(19) United States
(12) Patent Application Publication
(10) Pub. No.: US 2005/0079864 A1
(43) Pub. Date: Apr. 14, 2005

(54) Cellular radio telecommunication systems

(76) Inventors: Nicholas Dougall Johnson, St. Albans (GB); Neil Philip Piercy, Royston (GB)

Correspondence Address: Gregory J Lavorgna;Drinker Biddle & Reath, One Logan Square, 18th & Cherry Streets, Philadelphia, PA, 19103-6996, US

(21) Appl. No.: 10/332,890

(22) PCT Filed: Jul. 16, 2001
(86) PCT No.: PCT/GB01/03184

(30) Foreign Application Priority Data
Jul. 14, 2000 (GB) 0017430.0
May 16, 2001 (GB) 00111994.0

(51) Int. Cl. H04Q 7/20

(52) U.S. Cl. 455/422.1; 455/403

(57) ABSTRACT

A private cellular radio telecommunication system is provided that is arranged to support the handout of calls from the private system to an external cellular radio telecommunication system. The private system includes a base station controller that detects when a mobile subscriber unit within the private system with a call in progress, the call in progress not involving the external system, is about to move from the private system into the external system. To facilitate the handout of the call from the private system to the external system the base station controller of the private system sets up a “phantom” call through the external system, the “phantom” call being between the same part as is the call in progress so that as the mobile subscriber unit leaves the private system the phantom call takes over from the call in progress thus accomplishing handouts.

### TECHNICAL FIELD

This invention relates to private cellular radio telecommunication systems, and especially the interworking of such systems between themselves and with other non-radio telecommunication systems in handing over calls as mobile users move between systems.

Public telecommunication systems are set up to service subscribers over a wide geographical area and are interconnected with other public telecommunication systems to support calls between subscribers in different systems. In public cellular radio telecommunication systems, operators have set up their own networks of radio base stations to provide coverage for their own mobile subscriber units. Mobile subscriber units simply register locally with their network when they switch on, and their cellular location is then known to the system so that it can support outgoing calls or incoming calls with subscribers on the same network or other public telecommunication systems, fixed PSTN or mobile.

Private cellular radio telecommunication systems are set up to service users within a limited area of radio coverage so as to support internal calls between users. Typically, private systems are set up for in-building coverage.

It would be possible to set up a private cellular system so that its base stations are “seen by” an external public cellular system and the associated cells listed as neighbour cells in the public system. This set up will then facilitate the handover of calls between the two systems as a mobile subscriber unit moves from one to the other. However, the fact that the cells of the private system are likely to be much smaller than those of the public system means that the increased demand for channels to support these cells and mitigate co-channel interference problems, is likely to become excessive. However, the density of users in a private, in-building network, their relatively small size compared to public or macro cells, and their consequently high number, means that the number of neighbour relationships between cells to be administered by the public network could be very large indeed. It is possible, that with current technology, there could be more than ten times as many in-building cells as macro cells. The number of neighbour relationships between cells to be administered, maintained and tested could be up to two orders of magnitude greater than is the case today. Such a situation places considerable overhead on the Operations and Maintenance Centre (OMC) of any network, and currently contributes to the slow acceptance of in-building networks in the world today.

Where private in-building networks have the ability to route call traffic locally, without reference to the public cellular network, then an additional problem arises, when a mobile subscriber, engaged in such a locally routed call wishes to leave the coverage area of the private network and enter the coverage area of the public network. With current technology, the call is dropped at the point of leaving the private network, which leaves the mobile subscriber with a negative impression of the Quality of Service (QoS) they are receiving. The problem arises because with a locally routed call, the public network does not have resources allocated associated with the call, indeed it has no knowledge of the call at all, and so is unable to receive the normal handover signalling that accompanies mobile subscribers as they move about the network.

### DISCLOSURE OF THE INVENTION

According to one aspect, the invention consists in a private cellular radio telecommunication system comprising multiple basestations each of which corresponds to a radio cell, at least one of these cells, which corresponds to a physical entry point for mobile subscriber units into the private system, being designated as a “gateway” cell which is registered with an external macro network, whilst other cells are designated as private cells which are not registered with the external macro network.

Thus, the demand for channel allocation by the system is reduced, and the resources provided in the system for new hand-ins can be focussed on the gateway cell with rapid handover to a private cell to keep the hand-in resource available to the maximum extent possible.

According to a second aspect, the invention consists in a private cellular radio telecommunication system which is adapted to support the handout of calls to an external cellular radio telecommunication system, a controller being provided which detects when a mobile subscriber unit with a call in progress, not involving the external system, is about to move from the private system into the external system, and sets up a “phantom” call through the external system between the same parties as the call in progress so that the phantom call takes over from the call in progress as the mobile subscriber unit leaves the private system. The software agent that manages hand-in and hand-out from the private network is called the Handover Agent, or HA. This will typically, though not necessarily be executed on a computer local to the private cellular network.

Preferably, the system includes the feature of a gateway cell which is registered with the external system, and the controller detects when mobiles enter the gateway cell from within the private network, and act upon this to set up a “phantom” call. The phantom call can then take over from the call in progress before the mobile exits the gateway cell towards the external system, and conventional handout can then occur between the gateway cell and the external system.

### DESCRIPTION OF THE DRAWINGS

The invention will now be described by way of example with reference to the accompanying drawings in which:

FIG. 1 is a schematic drawing of a cellular radio telecommunication system according to the invention as applied to an in-building network, and

FIG. 2 is a schematic drawing showing set up of a phantom call for hand-out to an external public network.

### BEST MODE OF CARRYING OUT THE INVENTION

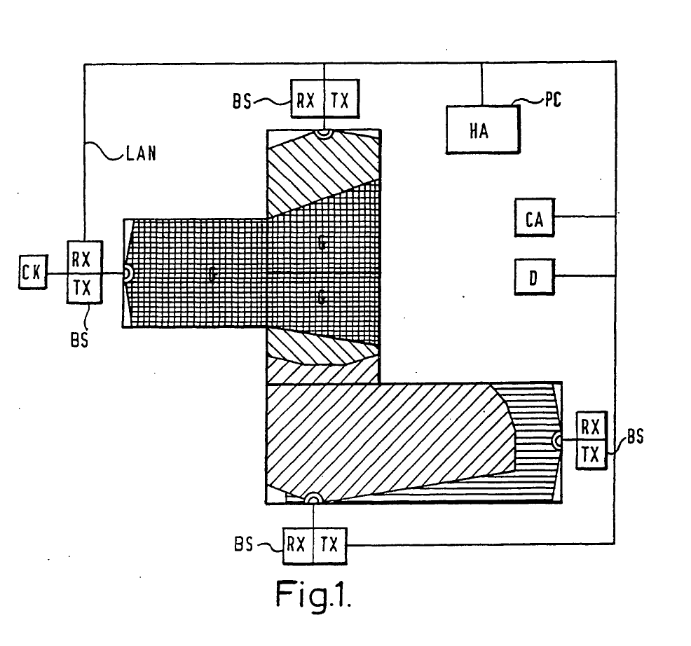

Consider the in-building network shown in FIG. 1. Each basestation BS contains one or more transmitters TX, one of which broadcasts a GSM beacon, containing the Basestation Control Channel BCCH so that the network is seen by a GSM external public network.

A controller PC is provided which is connected to the basestations via a packet switched local area network LAN and which incorporates a “handover agent” HA which interacts with the public network, so as to allow both hand-in from the public network to the private network, and hand-out from the private network to the public network.

The handover agent HA incorporates a cell planning model in which one or more basestations close to the physical entrance of the building in which the network resides are configured to form one cell called the “gateway cell” G and all other basestations are configured to form a second cell which is private to the network. The gateway cell G is entered in the public network neighbour cell list, but the private cell is a neighbour to the gateway cell only, and is not entered in the neighbour cell list of the, public network. Thus hand-in occurs into the gateway cell immediately followed by handover to the private cell under the control of the HA. The radio co-channel resources in the gateway cell that support hand-in, are therefore the only resources required, and are then kept free for new hand-ins.

An additional benefit of this process is that it prevents unwanted handover or location update attempts into the network from outside, as people inadvertently enter coverage of the network, for instance, by walking past windows.

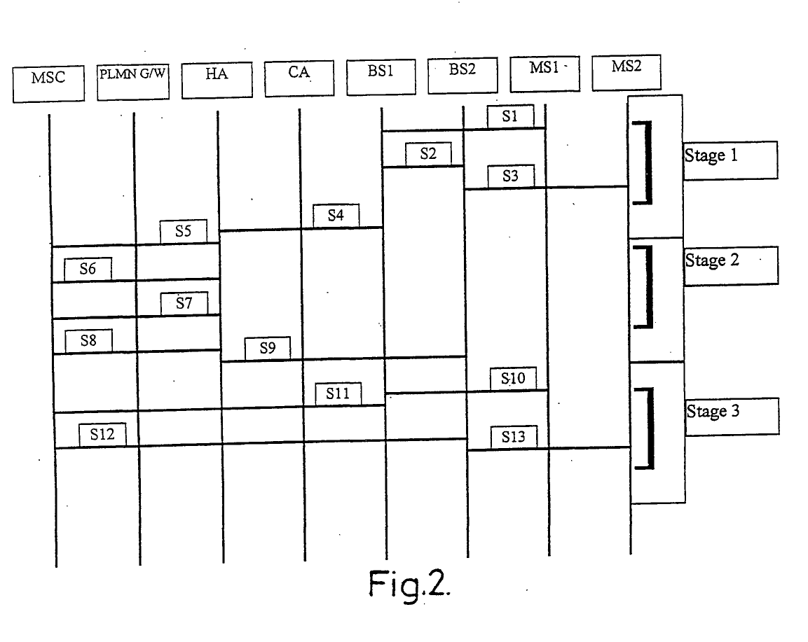

Consider a call routed totally on the network between two mobiles MS1 and MS2, each of which is located within the radio coverage of a respective basestation BS1 and BS2. Voice traffic between the two is routed through the basestations BS1 and BS2 over the LAN as directed by a “call agent” CA running on a controller connected to the LAN. This is represented as stage 1 in the handout procedure illustrated in FIG. 2. Call setup signalling for this call is omitted for clarity. S1 indicates speech or other traffic passing between MS1 and BS1. S2 indicates the traffic being routed to the opposite end point of the call, between BS1 and BS2. S3 indicates the corresponding speech or other traffic passing between MS2 and BS2. Note that some protocol conversion can take place at BS1 and BS2. For instance S1 and S3 may conform to GSM air interface standards, but S2 may conform to a VoIP protocol, such as H.323, for example.

The call agent CA communicates with the basestations, and the basestations route traffic between each other over the LAN using “a voice over internet protocol” VoIP signalling in accordance with a conventional standard such as H.323, SIP or H.248. The call agent controls call set up for mobile-originated calls and mobile-terminated calls within the network. It also controls connection of calls via a gateway D to a PBX network or IP telephony network.

Whilst an internal call is in progress between the two mobiles MS1 and MS2, the external public network has no knowledge of the call. Therefore, potentially, the call will fail if one of the mobiles leaves the building/network. In order to address this problem, the handover agent HA is adapted to detect movement of mobiles from a private cell into the gateway cell G using an algorithm such as diminishing network signals or increasing macro network signals. If we take BS1 in FIG. 2 to be such a gateway cell, then signal S4 indicates to the handover agent (HA) that the mobile subscriber is moving out of coverage of the gateway cell. The HA can then interrogate the Mobility Management Agent of the private network (not shown for clarity) to ascertain if the user is moving in or out of the private network. In the message sequence of FIG. 2, we assume such a signalling transaction indicates that the mobile is exiting the gateway cell, towards the public network. Movement of a mobile into the gateway cell G is interpreted as imminent exit from the network, shown as stage 2 in the handout procedure in FIG. 2. The handover agent HA therefore establishes a “phantom” call between the mobiles MS1 and MS2 over the public network via the gateway cell G, shown at stage 2 in the handout procedure in FIG. 2. The HA uses the subscription details of MS1 and MS2 (which it has stored during the initial call setup procedure) in setting up the phantom call. Signals S5 to S8 are an abbreviated call setup procedure into the mobile network. Note that some protocol conversion may occur at the PLMN G/W node, to translate the internal private network signalling into the standard required for the PLMN core network. For instance, it may translate H.323 signalling into SS7-MAP signalling and vice versa. Alternatively, the internal private network signalling may be translated into SS7-BSSMAP signalling and vice versa. Signal S5 is a call setup request signal, phantomed to appear as if it were from MS1. Signal S6 is a page request signal towards mobile MS2. The network knows to page MS2 here, since the private network will have informed the public network of this at the initial registration procedure, when MS2 was first switched on in the private network. The HA knows that an incoming page request for MS2 is really part of the phantom call procedure, so it responds with the usual call progress indications, as if it were MS2. Almost immediately, it will send the off-hook signal back to the network (S7) as if MS2 had answered the call. Then S8 confirms the call connected status of the phantom call. At this stage in the procedure, the HA is handling on traffic sourcing and sinking. At the successful establishment of the phantom call, the HA informs both BS1 and BS2 (signal S9) that they should route their call traffic through the PLMN, rather than to each other. This phantom call is established by the Base Station Controller BSC and Mobile Switching Centre MSC in the conventional manner. The HA then signals the basestations BS1 and BS2 to re-route the speech traffic to the macro network, shown as stage 3 in FIG. 2. The voice traffic is then re-routed over the public network, and conventional handout takes place between the gateway cell G and the public network if the mobile leaves the building.

The same handout procedure operates for calls which originate within the network, but terminate outside of the public network; for example, if a call within the network is gatewayed out of the network into a PBX network or the IP telephony network via the gateway D. In that case, replace BS2 with the PBX or IP telephony gateway, and MS2 with the fixed terminal. The same general signalling scheme applies.

1. A private cellular radio telecommunication system which is arranged to support the handout of calls to an external cellular radio telecommunication system, the private system including a controller which detects when a mobile subscriber unit with a call in progress, not involving the external system, is about to move from the private system into the external system, and sets up a “phantom” call through the external system between the same parties as the call in progress so that the phantom call takes over from the call in progress as the mobile subscriber unit leaves the private system.

2. A private cellular radio telecommunication system according to claim 1, wherein said private system includes a gateway cell registered with the external system, said controller detecting when said mobile subscriber unit enters the gateway cell and setting up said “phantom” call in response to said detection.

3. A private cellular telecommunication system according to any preceding claim comprising a plurality of basestations connected via said controller.

4. A private cellular telecommunication system according to claim 3, wherein one or more of said basestations are configured to form said gateway cell.

5. A private cellular telecommunication system according to claim 4, wherein at least one of the basestations configured as said gateway cell transmits a control channel frequency receivable by mobile subscriber units in said external system.

6. A private cellular telecommunication system according to any one of claims 4 to 5, wherein said basestations not configured to form said gateway cell are configured to form one or more private cells not registered with the external system.

7. A private cellular telecommunication system according to any preceding claim, wherein said controller comprises a handout agent that controls handout of calls to said external system.

8. A private cellular telecommunication system according to any preceding claim, wherein said controller comprises a call agent that controls call signals within said private system.

9. A private cellular telecommunication system according to claim 8, wherein said call agent performs protocol conversion between a first signalling protocol used by said private system and a second signalling protocol used by said external system.

10. A private cellular telecommunication system according to claim 9, wherein said call agent performs said protocol conversion when a mobile subscriber is located within said gateway cell.

11. A private cellular telecommunication system according to claim 9 or 10, wherein said pilot signalling protocol is one of H.323, SIP or H.248.

12. A private cellular telecommunication system according to claim 9 or 10, wherein said second signalling protocol is one from SS7-MAP and SS7-BSSMAP.

13. A private cellular telecommunication system according to any one of claims 7 to 12, wherein said handout agent stores the subscriber details of mobile subscriber units when a call within said private system is initiated between said mobile subscriber units.

14. A private cellular telecommunication system according to claim 13, wherein said handout agent uses said stored subscriber details to establish said “phantom” call when the detection of one of said mobile subscriber units entering said gateway cell occurs.

15. A method of handout from a private cellular radio telecommunication system to an external cellular radio telecommunication system, said private system comprising a gateway cell corresponding to a physical entry point into the private system, said gateway cell being registered with said external system, and a controller for effecting said handout, the method comprising the steps: detecting when a mobile subscriber with a call in progress enters said gateway cell; and setting up a “phantom” call through the external system between the same parties as in the call in progress, whereby said “phantom” call takes over the call in progress as the mobile subscriber leaves the private system.

16. A method according to claim 15, wherein said controller stores the subscriber details of the mobile subscriber units participating in the call in progress when said call is set up.

17. A method according to claim 16, wherein said controller sets up said “phantom” call through the external system by using said stored mobile subscriber details.

18. A method according to any one of claims 15 to 17, wherein said controller performs protocol conversion between a first signalling protocol used by said private system and a second signalling protocol used by said external system.

19. A private cellular radio telecommunication system comprising a plurality of basestations, said basestations being configured to form a plurality of cells within said private system, one of said cells corresponding to a physical entry point into the private system being designated a gateway cell, wherein said gateway cell is registered with an external cellular radio telecommunication system.
